(19) United States
(12) Patent Application Publication
(10) Pub. No.: US 2016/0312629 A1
(43) Pub. Date: Oct. 27, 2016

(54) APPARATUS FOR MOUNTING A BLADE ON A TURBINE DISK

(71) Applicants: Charles Evans, Tequesta, FL (US); Andrew Narcus, Loxahatchee, FL (US); Paul DiCristoforo, Monson, MA (US)

(72) Inventors: Charles Evans, Tequesta, FL (US); Andrew Narcus, Loxahatchee, FL (US); Paul DiCristoforo, Monson, MA (US)

(21) Appl. No.: 15/096,453

(22) Filed: Apr. 12, 2016

Related U.S. Application Data
(60) Provisional application No. 62/146,778, filed on Apr. 13, 2015.

(51) Int. Cl. F01D 5/30; F01D 5/02; F01D 5/12; F04D 29/32

(52) U.S. Cl. CPC F01D 5/3007; F04D 29/322; F04D 29/324; F01D 5/02; F01D 5/12; F05D 2220/30; F05D 2250/71

(57) ABSTRACT

A turbine wheel or disk having a plurality of dovetail slots formed in its circumference for receiving a dovetail root of a blade such as a compressor or turbine blade. Each of the dovetail slots has a load face positioned to oppose a centrifugal load exerted by the dovetail root when a turbine is in operation. Each of the dovetail slots has a pair of opposing acute bottom corners formed between a radially inner edge of the load face and a bottom of the dovetail slot. Each of the acute bottom corners may have an undercut formed that includes a first radius of curvature and a second radius of curvature to form a clearance between the dovetail root and the dovetail slot. Each of the dovetail slots may have a curved bottom for receiving a rounded dovetail root.

### FIELD OF THE INVENTION

This invention relates to the mounting of blades within slots formed within a circumference of a turbine disk, and more particularly, to a geometry of a blade mounting slot that reduces turbine disk stress.

### BACKGROUND OF THE INVENTION

Axial compressors and the hot gas path section of turbines, such as industrial gas turbines, have one or more rotating disks or wheels. Each disk holds an annular array of aerodynamic blades that extend radially from the disks' circumference. The blades may be mounted in respective dovetail slots formed within the disk circumference in a conventional retention configuration such as shown in FIG. 1. Stress concentrations around the mounting slot can cause failure in the disk.

### BRIEF DESCRIPTION OF THE DRAWINGS

The invention is explained in the following description in view of the drawings that show:

FIG. 1 is a front view of a turbine blade root installed in a dovetail or blade mount slot in a conventional configuration.

FIG. 2 is a front view of an exemplary turbine blade root installed in a dovetail or blade mount slot showing aspects of embodiments of the invention.

FIG. 3 is an enlarged front view of an exemplary acute corner of the dovetail or blade mount slot of FIG. 2 in accordance with aspects of the invention.

FIG. 4 is an enlarged front view of another exemplary acute corner of a dovetail or blade mount slot in accordance with aspects of the invention.

### DETAILED DESCRIPTION OF THE INVENTION

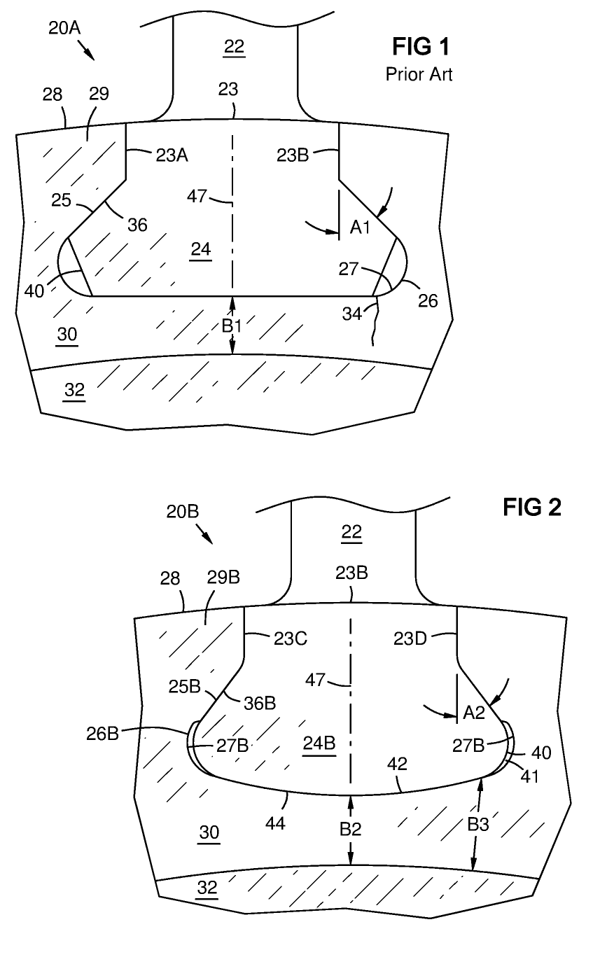

FIG. 1 is a front view of a turbine blade 22 assembled or integrated onto a platform 23 with first and second circumferentially opposite sides 23A, 23B. The platform has a dovetail root 24 inserted into a dovetail or blade mount slot 26 in the circumference 28 of a disk or wheel 29 in a configuration 20A illustrating aspects of prior art. The root has load faces 25 that bear against respective centrifugal load faces 36 of the slot. The slot load faces 36 may form an angle A1 of about 45 degrees relative to the circumferentially opposite sides 23A, 23B of the platform 23. In exemplary embodiments of the invention, turbine blade 22 may be one or more compressor blades mounted within respective slots of one or more compressor wheels 29 used within an industrial gas turbine, for example. Embodiments of the invention may be utilized in alternate turbine settings and are not limited to compressor blade and wheel combinations. Herein “circumferentially” means in a direction along or tangent to the circumference 28 of the disk. “Radially” means along a radius 47 of the disk. “Axially” means in a direction of the disk axis.

The disk may include an axially thick portion or webbing 30 to accommodate the axial length of the root 24, and a relatively thinner portion 32 to reduce weight. The slot 26 may have rounded acute corners 27. The root 24 may have truncated bottom corners 40 as shown or rounded bottom corners. In either case, stress concentrations occur around the acute corners 27 of the slot, especially for example in the location illustrated by a crack 34. Even if the thickness B1 of the webbing 30 is increased the stress concentration at 34 remains. With continued operation of a turbine with a cracked disk or wheel, the crack may continue to grow due to unit cyclic operation until the section average stress in the disk or wheel attachment post exceeds the alloy stress rupture capability, resulting in complete fracture of the attachment post and release of material into the turbine's flow path. This may cause significant damage to the turbine resulting in significant repair costs and scheduling concerns.

FIG. 2 is a front view of a turbine blade 22 assembled or integrated onto a platform 23B, such as by machining or casting, having first and second circumferentially opposite sides 23C, 23D. The platform has a dovetail root 24B that may be inserted into a dovetail or blade mount slot 26B in the circumference 28 of a disk 29B in a configuration 20B illustrating aspects of an embodiment of the invention. The root 24B has load faces 25B that bear against respective load faces 36B of the slot 26B under centrifugal force. The slot load faces 25B may form an angle A2 of about 37 degrees or be within a range of about 35-39 degrees relative to the circumferentially opposed sides 23C, 23D of the platform 23B. This range may vary in alternate embodiments as a function of dovetail and disk design parameters. The two acute corners 27B of the slot 26B may be undercut, which may make the slot 26B wider than the blade root 24B, creating clearance 41 between the acute corner 27B of the slot 26B and the corresponding obtuse corner 40 of the root 24B. This eliminates chafing between portions of the root 24B and slot 26B along these corners without requiring truncation of the root corners as in FIG. 1.

The undercut acute corners 27B of the slot 26B may have a single or compound radius of curvature, as disclosed more fully below, so that they merge smoothly or blend with the curvature of a concave bottom 42 of the slot 26B so as to avoid creating undesirable stress concentrations. The obtuse corners 40 of the root may be convex filleted to merge smoothly or blend with the curvature of a convex bottom 44 of the root 24B, which may match the concave bottom 42 of the slot 26B. It has been determined by the inventors of the present invention that stress concentrations around the acute corners 27B of the slot 26B are greatly reduced in the configuration 20B compared to configuration 20A of FIG. 1.

The minimum thickness B2 of the webbing may be increased over thickness B1 of FIG. 1. However, even if B2=B1, thickness B3 is increased over configuration 20A due to the curvature of the bottom 42 of the slot 26B

Technical analysis has revealed the following benefits in configuration 20B over 20A:

a) Peak disk stress is reduced by about 20%;

b) Stress is more uniformly distributed about the bottom of the slot;

c) High stresses do not exist along the length of the slot; and

d) The average LCF crack initiation prediction is improved by approximately 4.4 times.

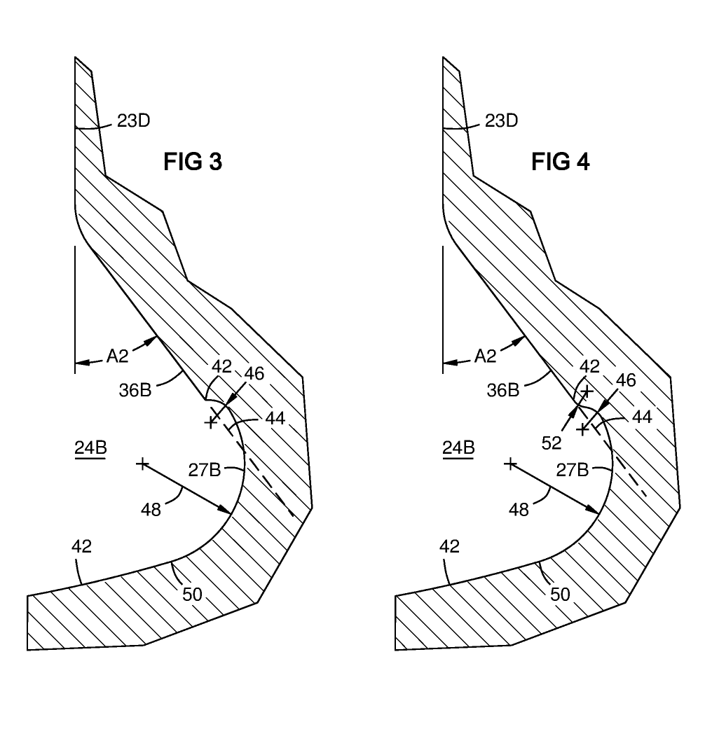

FIG. 3 is an enlarged front view of an acute corner 27B of a dovetail or blade mount slot 31 with an undercut that diverges from a plane 44 of the centrifugal load face 36B. This undercut may begin to diverge from a radially inner edge 42 of the load face 36B by a first relatively abrupt concave arc or curve 46 having a radius of curvature that merges smoothly with a second more gradual concave arc or curve 48 having a radius or curvature that in turn merges smoothly with a concave arc or curve of the bottom 42 of the slot at a common tangent point 50 of both curves 48, 42.

In an exemplary embodiment of the invention, concave arc or curve 46 may be formed with a radius of curvature of approximately 0.018 inches (0.45 mm), concave arc or curve 48 may be formed with a radius of curvature of approximately 0.130 inches (3.30 mm) and concave arc or curve of the bottom 42 may be formed with a radius of curvature of approximately 2.00 inches (50.08 mm). The transition portions of blade mount slot 31 between concave curves or arcs 46, 48, 42 may be formed so that the transition from one radius of curvature to the next is relatively smooth with no abrupt or stepped portions that may cause undesirable stress concentrations. Embodiments of the invention also allow for concave arc or curve 48 to intersect or join with concave arc or curve 48 at a first common tangent point along the undercut, and for concave arc or curve 48 to intersect of join with the concave bottom 42 at a second common tangent point. It will be appreciated that both acute corners 27B of FIG. 2 may be formed as mirror images having the above radii.

FIG. 4 shows an exemplary embodiment of the invention as in FIG. 3 further including a convex fillet 52 between the bottom edge 42 of the load face 36B and the first concave arc or curve 46 of the undercut. The undercut may be formed with a continuous curve rather than discrete arcs. The concave curve of the bottom 42 of the slot may be continuous with such continuous curve. For example, the undercut curve may be defined by a polynomial or spline function. The curve of the bottom 42 of the slot may be additionally included in such function.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A turbine disk comprising:
a dovetail slot formed in a circumference of the turbine disk for receiving a dovetail root of a blade;
a load face in the dovetail slot, the load face positioned to oppose a centrifugal load exerted by the dovetail root;
an acute bottom corner formed in the dovetail slot between a radially inner edge of the load face and a bottom of the dovetail slot; and
an undercut formed in the acute bottom corner that widens a portion of the dovetail slot beyond a width of the dovetail root.

2. The turbine disk of claim 1, wherein the bottom of the dovetail slot forms a concave curvature, and wherein the undercut diverges from the radially inner edge of the load face by a first concave arc having a first radius of curvature, the first concave arc having a first common tangent point with a second concave arc having a second radius of curvature, the second concave arc having a second common tangent point with the concave curvature of the bottom of the slot; and
wherein the first radius of curvature is smaller than the second radius of curvature.

3. The turbine disk of claim 1, wherein the bottom of the dovetail slot forms a concave curvature; and
wherein the undercut diverges from the radially inner edge of the load face by a first concave arc that merges smoothly with a second more gradual concave arc that merges smoothly with the concave curvature of the bottom of the dovetail slot.

4. The turbine disk of claim 3, wherein the first and second concave arcs join at a first common tangent point and the second concave arc and the concave curvature of the bottom of the slot join at a second common tangent point.

5. The turbine disk of claim 1, wherein the load face in the dovetail slot forms an angle to receive the centrifugal load exerted by the dovetail root, the angle formed between approximately 35 and 39 degrees with respect to the turbine disk radius.

6. The turbine disk of claim 5, wherein the bottom of the dovetail slot forms a concave curvature; and
wherein the undercut diverges from the radially inner edge of the load face by a first concave arc that merges smoothly with a second more gradual concave arc that merges smoothly with the concave curvature of the bottom of the dovetail slot.

7. The turbine disk of claim 6, wherein the first concave arc intersects with the second more gradual concave arc at a first common tangent point; and
wherein the second more gradual concave arc intersects with the concave curvature of the dovetail slot at a second common tangent point.

8. A disk for retaining a plurality of blades within a turbine, the disk comprising:
a plurality of dovetail slots formed in a circumference of the disk for receiving a respective root portion of a blade;
a first load face and a second load face in each of the plurality of dovetail slots that oppose a centrifugal load from a respective root portion of a blade during operation of the turbine;
a pair of opposing acute bottom corners formed in each of the plurality of dovetail slots, the pair of opposing acute bottom corners formed between a radially inner edge of the first load face and a radially inner edge of the second load face, and a bottom of the dovetail slot; and
an undercut formed within each of the pair of opposing acute bottom corners wherein the undercuts widen a portion of the dovetail slot beyond a maximum width of the respective blade root portion.

9. The disk for retaining a plurality of blades within a turbine of claim 8, each of the pair of opposing acute bottom corners further comprising:
a first concave arc having a first radius of curvature; and
a second concave arc having a second radius of curvature wherein the first radius of curvature is smaller than the second radius of curvature.

10. The disk for retaining a plurality of blades within a turbine of claim 9, wherein the bottom of the dovetail slot forms a concave curvature; and
wherein the first concave arc intersects with the second concave arc at a first common tangent point and the second concave arc intersects with the concave curvature of the bottom of the dovetail slot at a second common tangent point.

11. The disk for retaining a plurality of blades within a turbine of claim 10, wherein the first radius of curvature is approximately 0.018 inches and the second radius of curvature is approximately 0.130 inches and the concave curvature of the bottom of the dovetail slot has a radius of curvature of approximately 2.00 inches.

12. The disk for retaining a plurality of blades within a turbine of claim 8, wherein the first load face and the second load face each form an angle to receive the centrifugal load from a respective root portion of a blade during operation of the turbine, the angle formed between approximately 35 and 39 degrees with respect to the turbine disk radius.

13. The disk for retaining a plurality of blades within a turbine of claim 12, wherein a bottom of each of the plurality of dovetail slots forms a concave curvature.

14. The disk for retaining a plurality of blades within a turbine of claim 13, each of the pair of opposing acute bottom corners further comprising:
a first concave arc having a first radius of curvature; and
a second concave arc having a second radius of curvature wherein the first radius of curvature is smaller than the second radius of curvature.

15. The disk for retaining a plurality of blades within a turbine of claim 14, wherein the first radius of curvature is approximately 0.018 inches and the second radius of curvature is approximately 0.130 inches and the concave curvature of the bottom of the dovetail slot has a radius of curvature of approximately 2.00 inches.

16. A compressor wheel for a turbine comprising:
a plurality of dovetail slots formed in a circumference of the compressor wheel, each of the plurality of dovetail slots comprising:
a pair of opposing load faces positioned to oppose a centrifugal load exerted by a blade dovetail positioned within the dovetail slot during operation of the turbine;
a pair of opposing acute bottom corners formed between a radially inner edge of each of the pair of opposing load faces and a bottom of the dovetail slot, wherein each of the pair of opposing acute bottom corners is formed with an undercut having a first concave arc having a first radius of curvature and a second concave arc having a second radius of curvature wherein the first radius of curvature is smaller than the second radius of curvature; and
a bottom portion forming a concave curvature.

17. The compressor wheel of claim 16, wherein each of the pair of opposing load faces in the dovetail slot forms an angle to receive the centrifugal force exerted by the blade dovetail, the angle formed between approximately 35 and 39 degrees with respect to the compressor wheel radius.

18. The compressor wheel of claim 17, wherein the first radius of curvature is approximately 0.018 inches and the second radius of curvature is approximately 0.130 inches and the concave curvature of the bottom of the dovetail slot has a radius of curvature of approximately 2.00 inches.

19. The compressor wheel of claim 18, further comprising a plurality of compressor blades inserted within each of the plurality of dovetail slots.

20. The compressor wheel of claim 19, wherein each of the plurality of compressor blades has dovetail root forming a radius of curvature such that when the compressor blade is inserted with a respective dovetail slot a clearance is formed between the dovetail root and each of the pair of opposing acute bottom corners formed with the dovetail slot.
